(19) United States
(12) Patent Application Publication
(10) Pub. No.: US 2009/0066488 A1
(43) Pub. Date: Mar. 12, 2009

(54) Interactive wireless vehicle security system

(75) Inventors: Wang Qiahe, ShenZhen City (CN); Wu Hongliang, ShenZhen City (CN); Ray Wu, Jericho, NY (US)

Correspondence Address: THOMAS J. GERMINARIO, ESQ., 154 ROUTE 206, CHESTER, NJ, 07930, US

(73) Assignees: Shen Zhen Amwell Science; Tech Dev Co., Ltd.; 4G Technologies LLC

(21) Appl. No.: 11/898,397

(22) Filed: Sep. 12, 2007

(51) Int. Cl. B60R 25/10; G08B 13/00; H04M 11/04

(52) U.S. Cl. 340/426.1; 340/541; 455/404.2

(57) ABSTRACT

A security system detects intrusive activities in and around a vehicle and transmits warnings specifically describing the intrusions through a wireless telephone network to the owner's designated contacts. In response to the intrusion warnings, the vehicle owner or designees can establish remote wireless communication with the security system and obtain further information on the intrusion or initiate counter-measures to thwart an incipient theft.

### BACKGROUND OF THE INVENTION

1. Field of the Invention

The present invention relates to an interactive vehicle security system that uses a wireless communications module to notify the vehicle owner of detected intrusions and to receive and implement commands from the owner in response to these intrusions.

2. Related Prior Art

Conventional vehicle security systems respond to detected threats by sounding a loud alarm to attract attention to the theft activity. If the vehicle is parked in an isolated area, however, the sound of the alarm may not be heard. Even if there are people in the vicinity when the alarm sounds, they may not pay attention because of the frequency of false alarms. As for the owner, he or she will usually not be close enough to the vehicle to hear the alarm sound.

It is desirable, therefore, to have a vehicle security system that notifies the owner when his/her vehicle is being tampered with or has been stolen. It is also desirable that the security system notify the owner directly, rather than through a paid security service, as this enables the owner to respond more quickly and to avoid recurring charges of a vehicle security service.

The prior art in the field of vehicle security systems has recognized these needs and has responded to them in a variety of ways. In Reid, U.S. Pat. No. 5,027,104, a mobile radio transmitter is used to broadcast on an assigned frequency a warning to the owner that an intrusion has been detected. A second transmitter is used to transmit video signals at a second assigned frequency to a remote receiver so that the intrusion can be observed from a remote location. But the Reid security device has two major disadvantages. First, the owner must always carry with him a special radio unit to receive the warning messages. Second, there is no means provided for the owner to respond to the intrusion through a two-way communication with the vehicle security device.

A step in the direction of addressing the disadvantages of the Reid device is taught by Driori et al., U.S. Pat. No. 5,081,667. In order to avoid the inconvenience and expense of a dedicated transmitter-receiver system to send intrusion warnings, the Driori patent discloses a hardware and software interface to integrate a variety of cellular communication systems with vehicle security systems. In this way, the owner's car phone can be set up to call a designated contact number in the event the vehicle security system detects an intrusion. The Driori invention also has limited interactive capabilities, enabling the owner to initiate several actions telephonically, such as cutting off the engine or having voice communication with the thief.

Technological advances in wireless telephones since the Driori patent have rendered its complex and cumbersome universal interface system unnecessary to provide a vehicle security system with a wireless communication capability. The world's most widely used mobile telephony technology is now the digital system known as GSM (Global System for Mobile communication). A GSM module can be part of the vehicle security device itself, thus obviating the need for interfacing with a separate mobile telephone.

A GSM vehicle security system has other advantages as well. GSM telephony accommodates SIM cards (Subscriber Identity Module) holding network access configurations. This feature enables the vehicle owner to purchase a GSM security system independent of any local wireless service provider and to simply purchase a local access SIM card to insert into the GSM module.

GSM also has superior compatibility with emerging packet-based wireless services such as GPRS (General Packet Radio Services) and other advanced second generation (2.5G) and third generation (3G) wireless technologies, such as Enhanced Data GSM Environment (EDGE) and Universal Mobile Telecommunications Service (UMTS). Such 3G technology offers broadband, packet-based transmission of text, digitalized voice, video and multimedia at data rates up to 2 Mbps. Consequently, a GSM vehicle security system can incorporate capabilities for transmission to the owner, and/or the owner's computer, of digital photographs, streaming video, and/or GPS location coordinates of the stolen vehicle.

The evolution toward an interactive GSM vehicle security system appears in Yang, U.S. Pat. No. 6,542,072. The Yang invention provides interactive bi-directional communication between the owner and the security system. When the GSM system detects an intrusion, it sends a telephonic warning signal to the owner. Using a remote telephone, the owner can then contact the security system and, after entering a password, can cause the system to initiate various responsive actions, such as locking the doors or disabling the engine.

But the Yang system still has several major shortcomings. It has no ability to determine the specific type of intrusion in progress and report specific information to the vehicle owner so that he/she can determine the most appropriate response to make under the circumstances. For example, the situation in which a vehicle vibration sensor has been activated would call for an entirely different level of response than one involving an unauthorized door opening or ignition activation.

The Yang invention also lacks features to integrate it with a vehicle's existing or factory-installed vehicle security system and thus utilize existing security sensors (e.g. for hood, door, trunk openings, etc.). This drawback adds unnecessary expense to the system and is apt to cause problems of compatibility with the existing vehicle security system.

Also lacking in the Yang system are features to enable voice communications between the owner and the thief and/or monitoring (audio, photographic or video) of intrusive activities in and around the vehicle. These types of communications and monitoring functions are important to provide the owner with enough information to make informed decisions regarding anti-theft responsive actions.

After the Yang patent, subsequent refinements in the art have produced greater information content in wireless messaging to the owner. Two patents issued to Chen, U.S. Pat. Nos. 7,151,440 and 7,151,141 teach security systems that can notify the owner of a change in the vehicle's location based on monitoring of CGI or GPS coordinates. A patent to Otsuki et al., U.S. Pat. No. 7,151,440, describes a system that distinguishes different levels of vehicle intrusion in order to determine appropriate responsive measures. The published application of Chang, Pub. No. US 2006/0087411, discloses a system that transmits photographs and GPS coordinates to a remote web server accessible to the owner. And the published application of Fazio, Pub. No. US 2006/0192659, discloses a system that sends photographs and short video clips of intrusive activity to the owner's cell phone or e-mail. But none of these five patent documents teaches an interactive system that enables the owner to initiate anti-theft actions in the vehicle based on the information he/she receives.

The patent to Becker et al., U.S. Pat. No. 7,064,657, describes an interactive vehicle security system. The system sends a wireless intrusion warning message to the owner, who may then call the system and activate cameras to send him/her photographic or video images of the vehicle interior and exterior. After remotely viewing these images, the owner can activate responses such as disabling the engine. But the Becker invention also has a major disadvantage. The information it provides to the owner regarding theft activity in and around the vehicle is limited to photo/video images. Even with multiple hidden cameras, many of the thief's actions will not be fully visible. Specific information as to why the vehicle alarm was activated—e.g., a mere vibration or broken window—would better and more quickly inform the owner of the urgency of the situation and the need for a rapid response.

Consequently, the prior art in the field of wireless vehicle security systems fails to provide a system that: (a) promptly informs the owner of the specific conditions that have triggered the system, (b) enables the owner to initiate a variety of anti-theft measures, including voice communication with the thief, in response to the specific conditions reported, (c) integrates with the existing or factory-installed vehicle alarm system and utilizes its sensor apparatus, and (d) uses a GSM module to enable enhanced reporting features, such as digital photography/video and GPS coordinates data, based on 2.5G and/or 3G technology.

### SUMMARY OF THE INVENTION

It is an object of the present invention to provide a vehicle security system that incorporates a GSM wireless communication module, by means of which the system notifies the owner, and/or other designated contact numbers (hereafter broadly referred to as the “owner”), of intrusive activity detected in and around the vehicle.

It is another object of the present invention to provide a vehicle security system which wirelessly transmits to the owner voice and/or text messages that specify the type of intrusive activity that has been detected.

It is yet another object of the present invention to provide a vehicle security system which enables the owner, upon receiving notification of the specific ongoing intrusive activity, to initiate remotely by telephone one or more responsive actions to counteract the intrusion, such as locking the doors, sounding alarms, calling the police, disabling the ignition, locking the steering wheel, or cutting off fuel to the engine.

It is still another object of the present invention to provide a vehicle security system with real-time interactive capabilities, such that the owner can remotely monitor, by wireless communication device or computer, real-time audio and/or photo/video of the intrusive activity, obtain real-time GPS coordinates of the vehicle, and/or initiate real-time verbal communication with the intruder.

It is a further object of the present invention to provide a wireless vehicle security system that readily integrates with the existing or factory-installed security system and utilizes existing sensors already installed in the vehicle to monitor indicators of intrusive activity.

It is yet a further object of the present invention to utilize the advanced capabilities of GSM digital mobile telephony, including such features' ability to obtain access to a variety of local wireless providers through use of SIM cards, and ability to upgrade to advanced second generation (2.5G) and third generation (3G) wireless functions, including broadband transmission of text, digital audio, video and multimedia.

It is still a further object of the present invention to enable the vehicle owner to enjoy the benefits of a comprehensive interactive vehicle security system without the need for hiring a security service to monitor the vehicle and report its status to him/her, thereby allowing responsive anti-theft action to be more timely and avoiding monthly security service fees.

These and other beneficial purposes are achieved by an interactive wireless security system that consists of a base unit, one or more remote keypads, and an array of intrusion sensors. The base unit comprises a central processing unit (the “CPU”), an internal clock, a GSM digital communications module (the “GSM Module”), a menu ROM, a message ROM, a memory RAM, a sensory interface, a communication interface, and a vehicle control interface. Optionally, the base unit can also include an A/V processor and/or a GPS module. The array of intrusion sensors can include sensors associated with pre-installed security systems that have come as original equipment with the vehicle or have previously been installed by the owner. The pre-installed sensors can be supplemented by dedicated sensors of the present invention.

Intrusion sensors can include, without limitation, a door sensor, for sensing close-open status of doors and/or lighting of interior dome light in response to door opening; a trunk sensor, for sensing close-open status of trunk; a bonnet sensor, for sensing close-open status of engine bonnet; a battery voltage sensor, for sensing variation of battery voltage; an ignition sensor, for sensing key cylinder insertions and/or ignition activation; a vibration/tilt sensor, for sensing unusual vibration, impact, and/or tilting of the vehicle; a motion/acceleration sensor, for sensing whether the car is in motion and/or accelerating; a motion sensor, for sensing intrusive movement within or in the vicinity of the vehicle; an acoustic sensor, for sensing sounds of breaking glass and/or door openings; a brake/gas pedal sensor, for sensing pressure applied to brake and/or gas pedals; a steering sensor, for sensing turning of steering wheel; a seat sensor, for sensing the weight of an intruder on the driver's seat; one or more AN (audio/visual) sensors, to obtain audio, photographic and/or video data of the car interior and/or exterior; and a GPS (Global Positioning System) sensor, to obtain GPS coordinates of the vehicles location.

Information from the intrusion sensors is supplied to the CPU through the sensory interface, which for certain types of sensors may need to convert analog readings into digital format. If a GPS or an A/V sensor is installed, information from this sensor will be supplied to the CPU through a GPS interface or an A/V processor, respectively. When the security system is on, the CPU is continually monitoring the readings of each intrusion sensor. Upon finding an abnormal status of an intrusion sensor, the CPU will first initiate a verification routine to confirm the reading and check to see that the sensor is not malfunctioning.

Once verification of abnormal status of an intrusion sensor is completed, the CPU will initiate responsive action in accordance with its programming. In all instances, the CPU will correlate the type of intrusion detected with one of a number of digital voice and/or text messages stored in the message ROM. The CPU then stores the message, including the date and time obtained from the internal clock, in the memory RAM, and transmits the message to the GSM module through the communication interface. The GSM module then sends the message to the pre-programmed contact telephone numbers and/or e-mail addresses.

The CPU can also be programmed to take other actions automatically, through the GSM module and/or the vehicle control interface, in response to specific intrusion indicators. For example, in response to intrusion sensors indicating vehicle vibration or movement in the vehicle's vicinity, the CPU can send a command through the vehicle control interface to lock the doors and sound the vehicle's horn or alarm siren. If one of the intrusion sensors indicates that the vehicle has been tilted, on the other hand, the CPU can be programmed to select from the message ROM the message that the vehicle is being towed away by a thief and to transmit that message through the communication interface to the GSM module, with direction that it be sent to police and emergency telephone numbers. And in response to a pressure reading from the gas pedal sensor, the CPU can be programmed to send a command through the vehicle control interface to disable the fuel pump so that fuel will stop flowing to the engine.

When the owner receives a message from the base unit specifying the type of intrusion and time of occurrence, he or she can initiate a number of responsive actions from the keypad, from a remote telephone, or, if supported by the local GSM service provider, from a computer or PDA. When the owner contacts the base unit through the GSM module, he or she can access the CPU by entering a pre-programmed password. Password authentication causes the CPU to access the menu ROM containing a series of digital voice instructions and menu prompts eliciting alternate choices. The menu prompts begin with the most general main menu level and progress to more specific sub-menus based on the owner's responses. The menu prompts are transmitted through the communication interface to the GSM module and from there to the owner.

By way of example, (see FIG. 3), the main menu can consist of four prompts: number one accessing CPU programming options, number two accessing GSM communications options, number three accessing intrusion sensor monitoring options, and number four accessing vehicle control options. If the owner presses number three on the keypad or on his/her telephone, for instance, he/she will access the sensor submenu consisting of prompts for the various sensors. If number seven corresponds to the GPS sensor, pushing seven on the keypad or telephone would retrieve current and previous GPS coordinates.

Each sub-menu (see FIG. 3) will contain prompts to go back to the next higher menu level and/or the main menu level. Thus, for example, when the owner has learned that the GPS coordinates of the vehicle are changing, he/she may go back to the main menu level and select the GSM communication submenu to send the vehicle's current GPS coordinates to the police. The owner may then return again to the main menu level and, selecting the vehicle control options, respond to the prompt to disable the fuel pump.

A fuller understanding of the features and advantages of the present invention will be gained from the ensuing detailed description of the preferred embodiments read in conjunction with the accompanying drawings.

### BRIEF DESCRIPTION OF THE DRAWINGS

FIG. 1 is an overview functional block diagram of an interactive wireless vehicle security system in accordance with the preferred embodiment of the present invention.

FIG. 2 is a detailed functional block diagram of the preferred embodiment, showing the components of the base unit and their interrelationship.

FIG. 3 is an exemplary menu scheme of the preferred embodiment, showing interactive options with respect to programming, communication, sensor monitoring and vehicle control, and submenus corresponding to each option.

### DETAILED DESCRIPTION OF THE PREFERRED EMBODIMENT

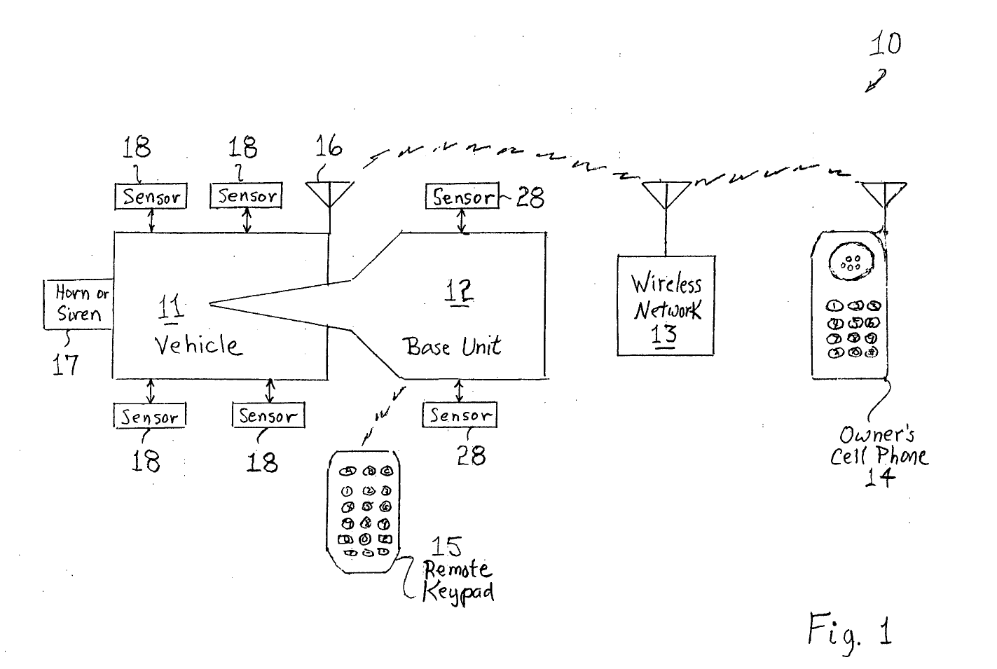

Referring to FIG. 1, we see an overview of the functional elements of the preferred embodiment of the present invention 10 depicted in block format. The primary functional elements comprise a vehicle 11 in which is installed a base unit 12. The base unit 12 is telephonically connected through a wireless network 13 to the owner's communication device 14 (which may be a cell phone, conventional phone, computer or PDA). One or more remote keypads 15 wirelessly communicates various commands (e.g. turn system on/off, lock/unlock doors, sound alarm, etc.) to the base unit 12. A wireless antenna 16 used for communicating with the wireless network 13 is installed in the vehicle 11, optimally in a location not readily observable.

The vehicle 11 is equipped with a factory-installed horn 17 and/or an alarm siren 17 that is part of an existing security system, either factory-installed or installed by the owner. In the event the vehicle's existing horn/siren is not suitable, a dedicated alarm siren 17 can be provided with the present security system 10. The vehicle 11 is also equipped with a plurality of pre-installed sensors 18, which may be factory-installed or part of a security system previously installed by the owner.

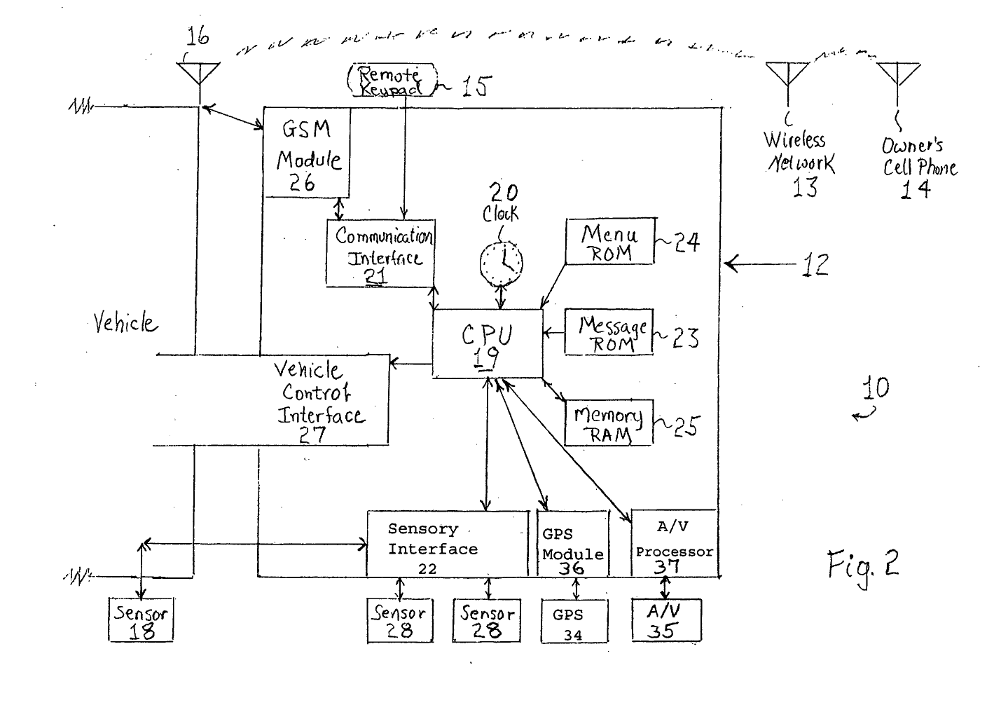

Referring to FIG. 2, the functional “heart” of the base unit 12 is a CPU 19. The CPU 19 continually receives digital data from certain components of the base unit 12, including an internal clock 20, a communication interface 21, and a sensory interface 22. Optionally, the CPU 19 continually receives digital data also from an A/V processor 37 and/or a GPS module 36, both of which are optional components of the base unit 12. The CPU 19 also can retrieve digital data from certain components of the base unit 12, including a message ROM 23, a menu ROM 24 and a memory RAM 25. The CPU 19 can also store data in the memory RAM 25 and can set/reset the internal clock 20.

The CPU 19 is also capable of controlling the operation of certain components of the base unit 12, including a GSM module 26, a vehicle control interface 27, the vehicle's pre-installed sensors 18, a plurality of dedicated sensors 28, as well as, optionally, a GPS sensor 34, and an A/V sensor 35.

Still referring to FIG. 2, the owner programs the base unit 12 using the remote keypad 15 and/or the owner's communication device 14. Using the owner's communications device 14, the owner initially sets up the base unit 12 by dialing the telephone number assigned to the GSM module 26 (or the SIM card inserted therein). If the present security system 10 is turned on, the GSM module 26 will send an incoming call signal through the communication interface 21 to the CPU 19.

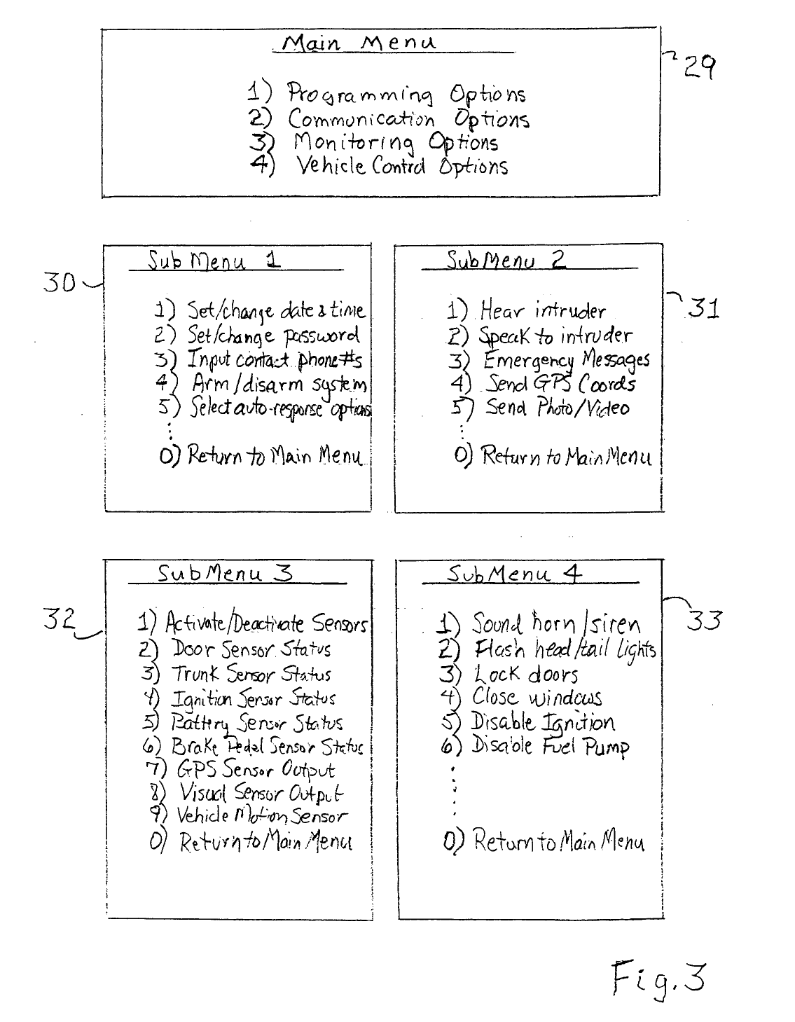

Referring now to FIG. 3, when the CPU 19 receives the incoming call signal, it will retrieve the main menu 29 and send it, in digital voice and/or text format, back through the communication interface 21 to the GSM module 26, which will then wirelessly transmit the voice and/or text of the main menu 24 through the wireless network 13 to the owner's communication device 14.

To perform the initial unit programming, the owner will respond to the prompts of the main menu 29 by selecting the programming option. For exemplary purposes, this option is designated as number one in the main menu shown in FIG. 3. Accordingly, the owner keys in the number one on the owner's communication device 14, which transmits it through the wireless network 13 to the GSM module 26, which in turn sends it through the communication interface 21 to the CPU 19.

Upon receiving the numerical response to the main menu prompts, the CPU 19 retrieves from the menu ROM 24 the corresponding submenu 30-33. For exemplary purposes, as shown in FIG. 3, the number one response to the main menu 29 causes the CPU 19 to retrieve submenu one 30 from the menu ROM 24 and to send it through the communication interface 21 to the GSM module 26 for transmission to the owner's communication device 14 through the wireless network 13.

In the initial setup of the base unit 12, the owner will hear or read a series of prompts such as those shown, for exemplary purposes, in submenu one 30 of FIG. 3. Keying in the number one in response to the prompts of submenu one 30, for example, will cause the CPU 19 to retrieve from the menu ROM 24 and transmit through the GSM module 26 a digital voice and/or text prompt to input numbers of the current date and time in a specified format using the owner's communication device 14. Similarly, if the owner keys in number two in response to the prompts of submenu one 30, the CPU 19 will cause to be retrieved and transmitted a prompt for the owner to input a sequence of numbers and/or characters as a password.

Using a programming submenu 30 of the exemplary type shown in FIG. 3, the owner can proceed during the initial setup process to set the date and time, set the password, and/or input contact telephone numbers and/or e-mail addresses to be contacted in the event of a detected intrusion. Certain of the submenu 30-33 prompts may access a sub-submenu. For example, option number five in submenu one 30 may access a sub-submenu (not shown) giving various anti-theft response actions for the CPU 19 to automatically initiate in response to certain circumstances. A sudden drop in battery voltage, for example, could cause the CPU 19 to automatically disable the ignition.

Once the initial setup of the base unit 12 is accomplished, the security system 10 is ready to function. When the owner parks the vehicle 11 and locks the doors, the system 10 will automatically be turned on or “armed.” If the owner forgets to lock the doors, he/she may remotely arm the system 10 using the remote keypad 15 or the owner's communication device 14. In the latter case, the owner could, for example, respond to prompt number four in submenu one 30.

With the system 10 in the “armed” mode, the CPU 19 will continually receive digital data through the sensory interface 22 on the status of the pre-installed sensors 18 and the dedicated sensors 28. Optionally, the CPU 19 continually receives digital data also through the A/V processor 37 from the A/V sensors 35 and/or through the GPS module 36 from the GPS sensor 34. By calling the base unit 12 and selecting monitoring options from the main menu 29, the owner can access a monitoring submenu 32, shown for exemplary purposes as submenu three in FIG. 3. In response to the voice and/or text prompts of the monitoring submenu 32, the owner can activate or deactivate certain sensors and can obtain a brief report of the status of active sensors.

If, for example, the owner wished to learn the door sensor status, he/she would key in on his/her communication device 14 the number two in response to the prompts of submenu three 32. This digital numerical datum would then be transmitted through the wireless network 13 to the GSM module 26, which would then send the datum through the communications interface 21 to the CPU. Upon receiving the number two in response to submenu three, the CPU 19 would, in this exemplary situation, retrieve data on the “locked/unlocked” and “open/closed” status of the doors from the door sensor 18 through the sensory interface 22. If sensor status data indicates that the doors are locked and closed, for instance, the CPU will retrieve the digital voice/text message “doors locked and closed” from the message ROM 23. The latter message will then be sent through the communications interface 21 to the GSM module 26 for transmission through the wireless network 13 to the owner's communication device 14.

When one of the sensors 18/28 detects an abnormal condition potentially associated with intrusive activity in or around the vehicle 11, the corresponding digital data will be sent through the sensory interface 22 to the CPU 19. The CPU 19 will then initiate a routine to confirm that the affected sensor is functioning properly and the sensor status has been accurately reported. After confirmation of an incident involving abnormal sensor status, the CPU 19 will retrieve from the internal clock the date and time of the incident and will store the incident data with its date and time in the memory RAM 25. In this way, even if an intruder subsequently finds and disables the base unit 10, evidence of the incident can be later recovered. The CPU 19 can be programmed to delete data stored in the memory RAM 25 after a certain retention period.

After storing the incident data, the CPU 19 will initiate any automatic responses to this incident type that the owner has selected from the programming submenu 30 during the setup of the base unit 12. Next the CPU 19 will retrieve from the message ROM 23 a digital voice and/or text message corresponding to the specific intrusive incident detected. The appropriate digital message along with date and time of the incident are then sent by the CPU 19 through the communication interface 21 to the GSM module 26 for wireless transmission to the contact telephone numbers and/or e-mail addresses which were input by the owner during the setup process.

Upon receiving a message specifying the time and nature of the intrusive incident, the owner will call the telephone number of the GSM module 26, which will cause the base unit 12 to transmit back to the owner the main menu 29, by the series of operations previously described above. In the exemplary format of the main menu 29 shown in FIG. 3, the owner might first select option number two to access communications submenu 31. An exemplary format of the communications submenu 31 is shown in FIG. 3. From such a communications submenu 31, the owner could choose to monitor sounds inside the vehicle, or to speak to the intruder, or to have the GSM module send emergency messages to the police, etc. From the communications submenu 31, or a similar type of submenu, the owner could also obtain additional information on the ongoing intrusion, including GPS coordinates, photographs and/or video, to the extent wireless transmission of such data is supported by the GSM service provider.

After obtaining as much information as possible from listening/speaking to the intruder and receiving GPS, photographic and/or video data, the owner could return to the main menu 29 from the communication menu 31 and next access the vehicle control submenu 33. An exemplary format of the vehicle control submenu 33 is shown as submenu four in FIG. 3.

By way of example, let us imagine that the owner has received a succession of messages indicating a door opened, battery voltage drop, vehicle in motion, and brake pedal depression. Using the communications submenu, the owner has heard an intruder's voice and has warned the thief that the police have been called, but to no avail. From the vehicle control submenu 33, the owner could at this juncture choose to disable the fuel pump, which is option number six on exemplary submenu four 33. The datum of the owner's selection of number six in response to the vehicle control submenu would then be received by the GSM module 26 and sent to the CPU 19 via the communication interface 21. Upon receiving this datum, the CPU 19 is programmed to send a signal through the vehicle control interface 27 which cuts off power to the fuel pump.

For safety reasons, the CPU 19 can be programmed to delay implementation of the fuel pump cut off command for a certain duration, during which periodic voice warning messages from the message ROM 23 of an impending engine stoppage can be addressed to the thief through the GSM module 26. Alternatively, the CPU 19 can be programmed to delay the fuel cut-off command until the sensors 18/28 indicate vehicle speed below a set limit, such as 20 m.p.h.

When A/V sensors 35 and/or a GPS sensor 34 are installed in the vehicle 11, the base unit 12 can optionally transmit photo/video and/or GPS data to a website maintained by a web server and accessible to the owner, provided that the wireless network 13 supports such transmissions. This feature will enable the owner to view GPS vehicle location mapping and/or photo/video images even if the owner's communication device does not support viewing of such mapping and/or images.

The present invention 10 can also optionally include a “panic button” feature for hijacking situations in which the owner is in the vehicle with the thief. By depressing a certain key on the remote keypad 15, for example, a crisis signal would be sent to the CPU 19 through the communications interface 21. In response to the crisis signal, the CPU 19 would retrieve a digital voice/text message, (such as “car hijacking in progress, black Mercedes, NY license #”) from the message ROM 23 and, if available, current vehicle location coordinates from the GPS sensor 34, and would cause the GSM module 26 to periodically transmit the message with current location to police and emergency contact telephone numbers and/or e-mail addresses.

The preferred embodiment of the present invention being thus described, it will be obvious that this invention may be modified in many ways with respect to specific features presented herein for exemplary purposes. Such modifications are not be regarded as departures from the scope of the present invention, but rather all such modifications as would be obvious to one skilled in the art are intended to be included in the following claims.

The invention claimed is:

1. An interactive wireless vehicle security system comprising:
(a) a vehicle in which is installed a wireless telephone antenna and base unit which telephonically communicates through a wireless network with one or more designated communication devices, whereby information concerning the vehicle's security is provided to the vehicle's owner and/or the owner's designees; and
(b) a plurality of sensors for detecting conditions indicative of unauthorized intrusion in and/or around the vehicle, which sensors continually communicate their current status to a central processing unit (CPU) located in the base unit; and
(c) a mobile communications module located in the base unit, which mobile communications module transmits outgoing messages sent from the CPU describing a specific current abnormal status of one or more of the sensors to the designated communication devices, and which mobile communications module receives incoming messages sent from the designated communication devices and relays such messages to the CPU; and
(d) a vehicle control interface, which receives command signals from the CPU in response to incoming messages from the designated communication devices, and which reacts to the command signals by activating or deactivating vehicle systems corresponding to the command signals, thereby executing counter-measures to thwart an incipient theft of the vehicle.

2. The interactive wireless vehicle security system according to claim 1, wherein the mobile communications module is a digital GSM module which can accommodate a SIM card for accessing the wireless network.

3. The interactive wireless vehicle security system according to claim 2, wherein the GSM module communicates with the CPU through a communications interface located in the base unit.

4. The interactive wireless vehicle security system according to claim 3, wherein the sensors communicate with the CPU through a sensory interface located in the base unit.

5. The interactive wireless vehicle security system according to claim 4, wherein the CPU retrieves current date and time data from an internal clock located in the base unit.

6. The interactive wireless vehicle security system according to claim 5, wherein commands can be sent to the CPU through the communication interface from one or more remote keypads located outside the base unit.

7. The interactive wireless vehicle security system according to claim 6, wherein the CPU, upon receiving and confirming data indicating an abnormal status of one of the sensors, retrieves a digital voice and/or text message specifically descriptive of the abnormal sensor status from a message ROM located in the base unit and sends the specific message through the communication interface to the GSM module to be transmitted via the wireless network to the designated communication devices.

8. The interactive wireless vehicle security system according to claim 7, wherein the CPU, upon receiving an incoming message from one of the designated communication devices, retrieves a main menu from a menu ROM located in the base unit and sends the main menu in digital voice and/or text format through the communications interface to the GSM module for transmission through the wireless network to the designated communication device.

9. The interactive wireless vehicle security system according to claim 8, wherein the main menu contains prompts for a plurality of menu options, which options can be selected by input from one of the designated communication devices, and certain of which options, when selected, can cause the CPU to send specific information on the current status of sensors, in the form of digital messages retrieved from the message ROM, to the GSM module to be transmitted to one or more of the designated communication devices, and certain other of which options, when selected, can cause the CPU to send command signals to the vehicle control interface to activate or deactivate vehicle systems corresponding to the command signals.

10. The interactive wireless vehicle security system according to claim 9, wherein the main menu options consist of or include options which, when selected by input from one of the designated communication devices, causes the CPU to retrieve one of a plurality of submenus from the menu ROM and to send the corresponding submenu in digital voice and/or text format through the communications interface to the GSM module for transmission through the wireless network to the designated communication device.

11. The interactive wireless vehicle security system according to claim 10, wherein each of the submenus contains prompts for a plurality of menu options, which options can be selected by input from one of the designated communication devices, and certain of which options, when selected, can cause the CPU to send specific information on the current status of sensors, in the form of digital messages retrieved from the message ROM, to the GSM module to be transmitted to one or more of the designated communication devices, and certain other of which options, when selected, can cause the CPU to send command signals to the vehicle control interface to activate or deactivate vehicle systems corresponding to the command signals.

12. The interactive wireless vehicle security system according to claim 11, wherein the system utilizes, in addition to its own dedicated sensors, pre-existing sensors, either factory-installed or part of a security device previously installed by the vehicle's owner.

13. The interactive wireless vehicle security system according to claim 12, wherein the CPU, upon receiving and confirming data indicating an abnormal condition of one of the sensors, stores the data, along with the current date and time obtained from the internal clock, in a memory RAM located in the base unit.

14. The interactive wireless vehicle security system according to any of claims 1 through 13, wherein the sensors include a GPS sensor that receives GPS coordinates of the current location of the vehicle and sends the GPS coordinates to the CPU through a GPS module located in the base unit.

15. The interactive wireless vehicle security system according to any of claims 9 through 13, wherein the remote keypad(s) has/have a crisis key, which when depressed causes a recurring message to be transmitted to designated police and/or emergency telephone numbers and/or e-mail addresses, which recurring message states that the vehicle has been hijacked and gives a description of the vehicle, its license plate, and its current location.

16. The interactive wireless vehicle security system according to claim 14, wherein the remote keypad(s) has/have a crisis key, which when depressed causes a recurring message to be transmitted to designated police and/or emergency telephone numbers and/or e-mail addresses, which recurring message states that the vehicle has been hijacked and gives a description of the vehicle, its license plate, and its current GPS coordinates.

17. The interactive wireless vehicle security system according to any of claims 1 through 13, wherein the sensors include an A/V sensor that obtains audio, photographic and/or video data of the interior and/or exterior of the vehicle and sends the data to the CPU through an A/V processor located in the base unit.

18. The interactive wireless vehicle security system according to claim 14, wherein the sensors further include an A/V sensor that obtains audio, photographic and/or video data of the interior and/or exterior of the vehicle and sends the data to the CPU through an A/V processor located in the base unit.

19. The interactive wireless vehicle security system according to claim 15, wherein the sensors include an A/V sensor that obtains audio, photographic and/or video data of the interior and/or exterior of the vehicle and sends the data to the CPU through an A/V processor located in the base unit.

20. The interactive wireless vehicle security system according to claim 16, wherein the sensors further include an A/V sensor that obtains audio, photographic and/or video data of the interior and/or exterior of the vehicle and sends the data to the CPU through an A/V processor located in the base unit.

21. The interactive wireless vehicle security system according to claim 14, wherein GPS coordinates of the vehicle's current location are periodically transmitted to a website accessible to the owner of the vehicle, whereon one or more digital mappings of the vehicle's past and current location are displayed.

22. The interactive wireless vehicle security system according to claim 16, wherein GPS coordinates of the vehicle's current location are periodically transmitted to a website accessible to the owner of the vehicle, whereon one or more digital mappings of the vehicle's past and current location are displayed.

23. The interactive wireless vehicle security system according to claim 17, wherein audio, photographic and/or video data from the interior and/or exterior of the vehicle are periodically transmitted to a website accessible to the owner of the vehicle, whereon sounds and/or images of the interior and/or exterior of the vehicle are replayed and/or displayed.

24. The interactive wireless vehicle security system according to claim 19, wherein audio, photographic and/or video data from the interior and/or exterior of the vehicle are periodically transmitted to a website accessible to the owner of the vehicle, whereon sounds and/or images of the interior and/or exterior of the vehicle are replayed and/or displayed.

25. The interactive wireless vehicle security system according to claim 18, wherein GPS coordinates of the vehicle's current location and audio, photographic and/or video data from the interior and/or exterior of the vehicle are periodically transmitted to a website accessible to the owner of the vehicle, whereon one or more digital mappings of the vehicle's past and current location are displayed, and whereon sounds and/or images of the interior and/or exterior of the vehicle are also replayed and/or displayed.

26. The interactive wireless vehicle security system according to claim 20, wherein GPS coordinates of the vehicle's current location and audio, photographic and/or video data from the interior and/or exterior of the vehicle are periodically transmitted to a website accessible to the owner of the vehicle, whereon one or more digital mappings of the vehicle's past and current location are displayed, and whereon sounds and/or images of the interior and/or exterior of the vehicle are also replayed and/or displayed.
